(19) United States
(12) Patent Application Publication
(10) Pub. No.: US 2026/0258808 A1
(43) Pub. Date: Sep. 3, 2026

(54) PUMP-OPERATION SUPPORT METHOD AND PUMP-OPERATION SUPPORT APPARATUS

(71) Applicant: EBARA CORPORATION, TOKYO (JP)

(72) Inventors: Yasumasa YAMADA, TOKYO (JP); Yuta SAKAMAKI, TOKYO (JP); Hyunwoo PARK, TOKYO (JP)

(21) Appl. No.: 18/873,072

(22) PCT Filed: Apr. 7, 2023
(86) PCT No.: PCT/JP2023/014340

§ 371 Date: Dec. 9, 2024

(30) Foreign Application Priority Data
Jun. 13, 2022 (JP) 2022-095238

(51) Int. Cl. F04D 27/00

(52) U.S. Cl. CPC F04D 27/00

(57) ABSTRACT

The present invention relates to a pump-operation support method and a pump-operation support apparatus. The pump-operation support method includes: a performance-characteristic acquisition process of acquiring a flow-rate vs. total-pump-head typical performance curve in a rated operation and a rated rotational speed as performance characteristics of a support target device identified by the model number of a pump device; an installation-state acquisition process of acquiring an actual pump head as an installation state of the support target device; an operation-state acquisition process of acquiring operating frequency, suction pressure, and discharge pressure as an operation state of the support target device; and a first operation support process of calculating operating conditions in a reference operation of the support target device when the support target device is operated in the installation state and the operation state, wherein the first operation support process includes calculating flow rate and total pump head in the reference operation based on the performance characteristics, the installation state, and the operation state.

### TECHNICAL FIELD

The present invention relates to a pump-operation support method and a pump-operation support apparatus.

### BACKGROUND ART

Conventionally, when a pump device is operated in a certain environment, an actual flow rate is measured using a flow meter, so that an operating point of the pump device is checked (see, for example, Patent Document 1).

### CITATION LIST

### Patent Literature

Patent document 1: Japanese laid-open patent publication No. H09-112440

### SUMMARY OF INVENTION

### Technical Problem

In order to check the operating point of the pump device using the method disclosed in Patent Document 1, it is necessary to prepare the expensive flow meter in advance and install the flow meter at an installation site of the pump device. Therefore, there is a demand for a method for easily checking the operating point of the pump device at the installation site of the pump device. In addition, there is a demand for a method for checking the operating point of the pump device not only at the installation site of the pump device but also at a remote management sensor away from the installation site. Furthermore, there is a demand for a method for checking not only a current situation at a time of installation of the pump device but also, for example, the operating point when the pump device was operated in the past.

In view of the above-mentioned problem, the present invention provides a pump-operation support method and a pump-operation support apparatus that enable easy operation support for a pump device without using a flow meter.

### Solution to Problem

In order to achieve the above object, a pump-operation support method according to an embodiment of the present invention of supporting operation of a pump device using a computer, comprises:
a performance-characteristic acquisition process of acquiring a flow-rate vs. total-pump-head typical performance curve (QH_{typical}(Q)) in a rated operation and a rated rotational speed (N_{rated}) as performance characteristics of a support target device identified by the model number (Mn) of the pump device;
an installation-state acquisition process of acquiring an actual pump head (H_{static}) as an installation state in which the support target device is installed;
an operation-state acquisition process of acquiring operating frequency (Fₒᵤₜ), suction pressure (P_{suction}), and discharge pressure (P_{discharge}) as an operation state of the support target device when the support target device is operated in the installation state; and
a first operation support process of calculating operating conditions in a reference operation of the support target device when the support target device is operated in the installation state and the operation state,
wherein the first operation support process includes calculating flow rate (Q_{now}) and total pump head (H_{now}) in the reference operation based on the performance characteristics, the installation state, and the operation state.

### Advantageous Effects of Invention

According to the pump-operation support method of the present invention, the first operation support process calculates the flow rate (Q_{now}) and the total pump head (H_{now}) in the reference operation as the operating conditions for the reference operation of the support target device when operated in its installation state and its operation state, based on the performance characteristics of the support target device acquired in the performance-characteristic acquisition process, the installation state of the support target device acquired in the installation-state acquisition process, and the operation state of the support target device acquired in the operation-state acquisition process. Therefore, operation support for the pump device can be easily conducted without using a flow meter.

Objects, configurations, and effects other than those described above will be made clear in detailed descriptions of the invention described below.

### BRIEF DESCRIPTION OF DRAWINGS

FIG. 1 is an overall configuration diagram showing an example of a pump-operation support system 1;

FIG. 2 is a block diagram showing an example of a pump-operation support apparatus 3;

FIG. 3 is a data configuration diagram showing an example of operation-support acquisition data 321 and a pump database 40;

FIG. 4 is a data configuration diagram showing an example of operation-support internal data 322;

FIG. 5 is a hardware configuration diagram showing an example of a computer 900 constituting each device;

FIG. 6 is a flowchart showing an example of a pump-operation support method performed by the pump-operation support apparatus 3;

FIG. 7 is a diagram showing an example of a model-number input screen 10;

FIG. 8 is a diagram showing an example of an installation-use input screen 11;

FIG. 9 is a diagram showing an example of an actual-pump-head input screen 12;

FIG. 10 is a diagram showing an example of an operating-frequency input screen 13;

FIG. 11 is a diagram showing an example of a pressure input screen 14;

FIG. 12 is a diagram showing an example of a measurement-point-height-difference input screen 15;

FIG. 13 is a flowchart showing an example of a first operation support process (step S200) performed by a first operation support section 303;

FIG. 14 is a flowchart (continuation of FIG. 13) showing an example of the first operation support process (step S200) performed by the first operation support section 303;

FIG. 15 is a graph showing a flow-rate vs. total-pump-head performance curve (QH_{now}(Q)) in a reference operation, and an example of calculation of the total pump head (H_{now}) in the reference operation and the flow rate (Q_{now}) in the reference operation;

FIG. 16 is a graph showing an example of calculation of a system curve (CV_{sys}(Q)) and flow rate (Q_{rated}) and total pump head (H_{rated}) in a rated operation;

FIG. 17 is a graph showing a relationship between flow rate and total pump head in the reference operation, and a relationship between flow rate and power consumption;

FIG. 18 is a diagram showing an example of a first operation support screen 16;

FIG. 19 is a flowchart showing an example of a second operation support process (step S300) performed by a second operation support section 304;

FIG. 20 is a flowchart (continuation of FIG. 19) showing an example of the second operation support process (step S300) performed by the second operation support section 304;

FIG. 21 is a diagram showing an example of a second operation support screen 17;

FIG. 22 is a graph showing a relationship between flow rate and total pump head in a set flow-rate operation, and a relationship between flow rate and power consumption; and

FIG. 23 is a diagram showing an example of a second operation support screen 17a after updated.

### DESCRIPTION OF EMBODIMENTS

Embodiments for practicing the present invention will be described below with reference to the drawings. In the following descriptions, scope necessary for the descriptions to achieve the object of the present invention will be schematically shown, scope necessary for the descriptions of relevant parts of the present invention will be mainly described, and parts omitted from the descriptions will be based on known technology.

### Embodiment

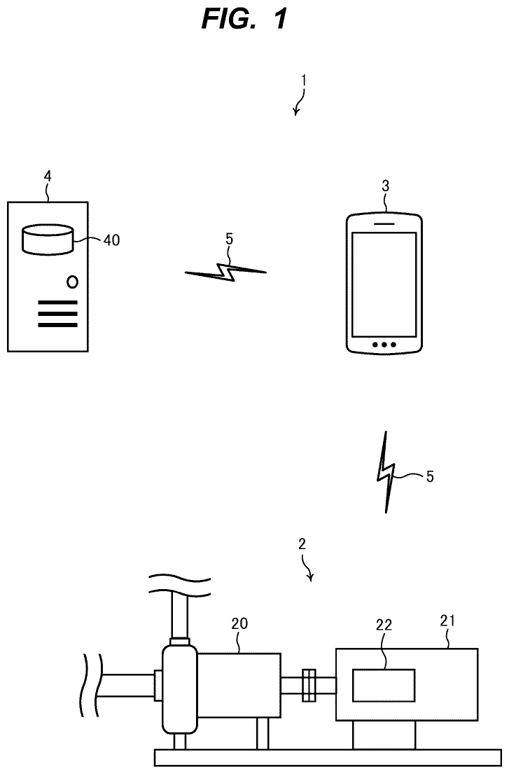

FIG. 1 is an overall configuration diagram showing an example of a pump-operation support system 1. The pump-operation support system 1 functions as a system that supports a user of a pump device 2 (an owner, a manager, a working person for installation, inspection, repair, etc. of the pump device 2) in setting operating conditions of the pump device 2 when the pump device 2 is installed as a support target device.

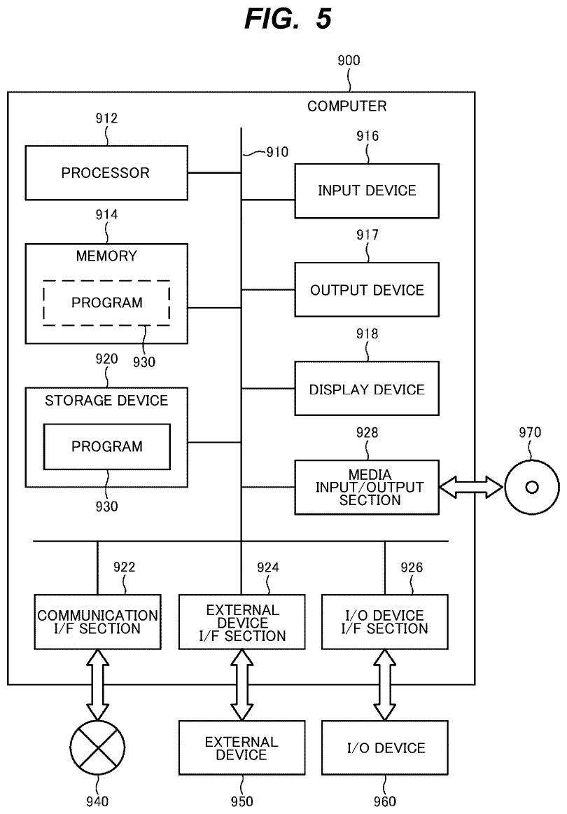

Specifically, the pump-operation support system 1 includes, as its specific components, the pump device 2 as a support target device, a pump-operation support apparatus 3 used by a user of the pump device 2, and a pump database device 4 configured to manage data related to performance characteristics of the pump device 2. Each of the devices 2 to 4 is configured, for example, by a general-purpose or dedicated computer (see FIG. 5 described later), and is configured to be able to transmit and receive various data to and from each other via a network 5. It is noted that each of the devices 2 to 4 may be a plurality of devices, and configuration of the network 5 is not limited to the example shown in FIG. 1.

The pump device 2 is a rotary machine that delivers a liquid, such as water (tap water, sewage, fresh water, seawater, industrial water, etc.), chemical liquid, petroleum (crude oil, refined oil), etc. The pump device 2 is used, for example, in a water supply facility (e.g., a water supply system, sewage system) and a plant facility (e.g., oil refining facility, power generation facility, manufacturing facility, and chemical process facility), while the pump device 2 is not limited to these examples and may be used in a system that uses any liquid. It is noted that in embodiments described below, the support target device is applied to the pump device 2 that functions as a water supply device configured to deliver water.

The pump device 2 includes a pump section 20, a motor 21 serving as a drive source of the pump device 2, and a pump controller 22 configured to control operation of the pump device 2. The pump section 20 is composed of, for example, an impeller, a rotation shaft, a bearing, a mechanical seal, a gland packing, a casing, and a pipe. The pump controller 22 is composed of, for example, an inverter, a power supply circuit, a communication circuit, an operation display unit, and the like. The pump controller 22 controls rotating operation of the motor 21 based on, for example, a command frequency set and instructed as an operating condition and a detection value of a sensor (not shown) provided in each section, and controls communication operations when transmitting and receiving various information between the pump-operation support apparatus 3 and the pump database device 4. The motor 21 may be composed of a motor unit that includes at least one of an inverter and a power supply circuit.

There are multiple types of pump devices 2 with different performance characteristics, and the performance characteristics are identified by the model number. Examples of the performance characteristics include, but are not limited to, a flow-rate vs. total-pump-head typical performance curve in a rated operation, a flow-rate vs. power-consumption typical performance curve, a rated rotational speed, and the number of motor poles. The model number is expressed, for example, by a string of alphanumeric characters, and may identify not only the performance characteristics of the pump device 2 but also various specifications of the pump device 2 (structure, material, pomp bore, etc.).

The pump-operation support apparatus 3 is configured, for example, by a stationary computer or a portable computer, and is used by a user of the pump device 2. Programs, such as applications and browsers, are installed in the pump-operation support apparatus 3, and the pump-operation support apparatus 3 accepts various input operations and outputs various information (screen information, etc.) via a display screen or voice. In this embodiment, the pump-operation support apparatus 3 will be described mainly in a case where it is configured by a smartphone as an example of a portable computer, as shown in FIG. 1.

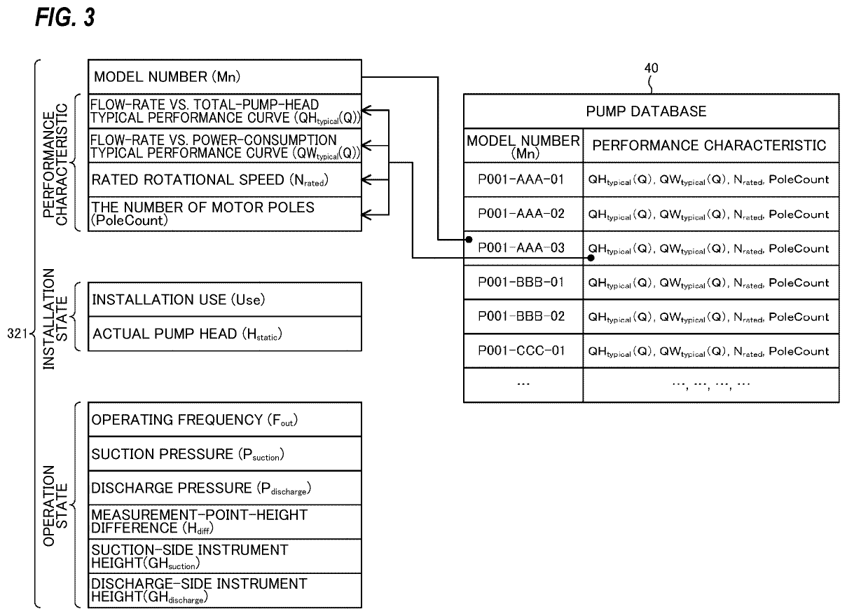

The pump database device 4 is configured, for example, by a server-type computer or a cloud-type computer. The pump database device 4 includes a pump database 40 (see FIG. 3 described later) for each model number of the pump device 2. Performance characteristic data indicating the performance characteristics of each pump device 2 can be registered in the pump database 40. When the pump database device 4 receives a data-transmission request including the model number of the pump device 2 from the pump-operation support apparatus 3, the pump database device 4 reads out the performance characteristic data corresponding to the model number from the pump database 40 and transmits the performance characteristic data to the pump-operation support apparatus 3 that has transmitted the data-transmission request.

The network 5 is configured by wired communication or wireless communication, or a combination of wired communication and wireless communication, according to any communication standard. Specifically, for example, a standardized communication network, such as the Internet, a communication network managed within a building, such as a local network, or a combination of these communication networks can be used. Furthermore, an international standard is typically used as the communication standard for wireless communication. Examples of communication means of the international standard include IEEE802.15.4, IEEE802.15.1, IEEE802.15.11a, 11b, 11g, 11n, 11ac, 11ad, ISO/IEC14513-3-10, IEEE802.15.4g. In addition, systems, such as Bluetooth (registered trademark), Bluetooth Low Energy, Wi-Fi, ZigBee (registered trademark), Sub-GHz, EnOcean (registered trademark), and LTE can also be used.

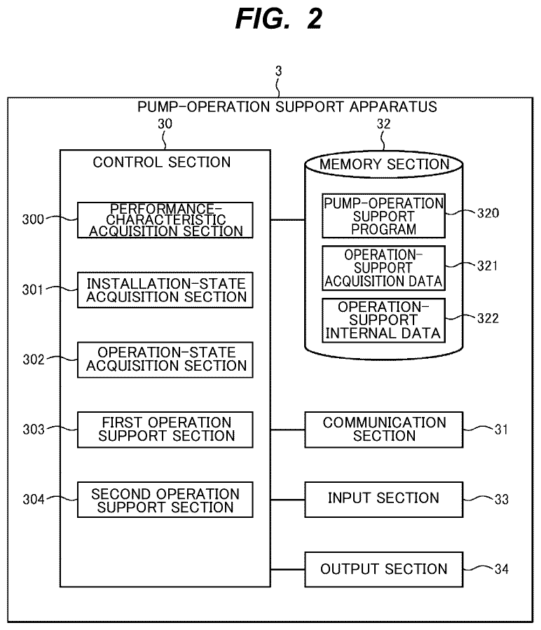

FIG. 2 is a block diagram showing an example of the pump-operation support apparatus 3. The pump-operation support apparatus 3 includes, as its main components, a control section 30, a communication section 31, a memory section 32, an input section 33, and an output section 34.

The control section 30 functions as a performance-characteristic acquisition section 300, an installation-state acquisition section 301, an operation-state acquisition section 302, a first operation support section 303, and a second operation support section 304, for example, by executing a pump-operation support program 320 stored in the memory section 32. Specifically, each of the sections 300 to 304 of the control section 30 functions as an entity that performs each process (a performance-characteristic acquisition process, an installation-state acquisition process, an operation-state acquisition process, a first operation support process, and a second operation support process) in the pump-operation support method.

The communication section 31 is coupled to the network 5 and functions as a communication interface for transmitting and receiving various data to and from, for example, the pump device 2 or the pump database device 4. The memory section 32 stores various programs (such as an operating system and the pump-operation support program 320) and data (such as operation-support acquisition data 321 and operation-support internal data 322) used in the operation of the pump-operation support apparatus 3. The input section 33 accepts various input operations, and the output section 34 functions as a user interface by outputting various information via display screen or voice.

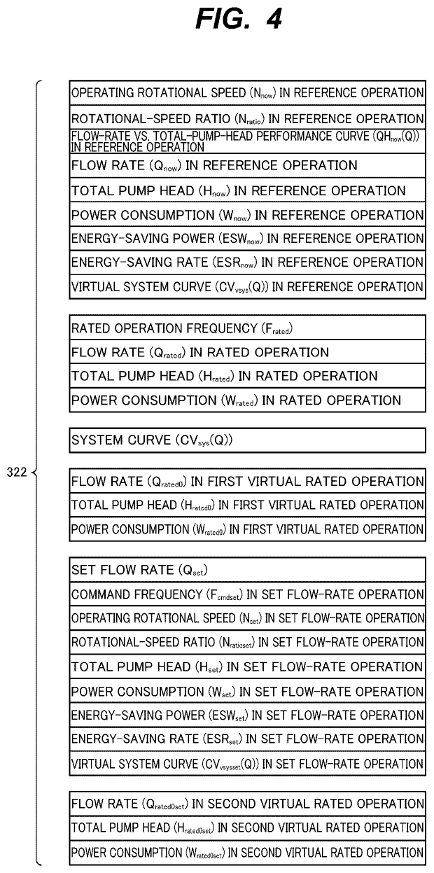

FIG. 3 is a data configuration diagram showing an example of the operation-support acquisition data 321 and the pump database 40. FIG. 4 is a data configuration diagram showing an example of the operation-support internal data 322.

Data indicating the performance characteristics of each pump device 2 (in the example of FIG. 3, flow-rate vs. total-pump-head typical performance curve (QH_{typical}(Q)), flow-rate vs. power-consumption typical performance curve (QW_{typical}(Q)), rated rotational speed (N_{rated}), and the number of motor poles (PoleCount)) is registered in the pump database 40 for each model number of the pump device 2. The pump database 40 is appropriately updated by adding, modifying, or deleting the model number and the performance characteristics based on information provided by a manufacturer of the pump device 2, for example.

The operation-support acquisition data 321 contains data of performance characteristic acquired by the performance-characteristic acquisition section 300, data of installation state acquired by the installation-state acquisition section 301, and data of operation state acquired by the operation-state acquisition section 302 when the pump-operation support apparatus 3 is operating. The operation-support internal data 322 contains data of processing result (intermediate calculation result, final calculation result, etc.) of the operation support process performed by the first operation support section 303 and the second operation support section 304 when the pump-operation support apparatus 3 is operating. The processes of acquiring and calculating the various data stored in the operation-support acquisition data 321 and the operation-support internal data 322 will be described later.

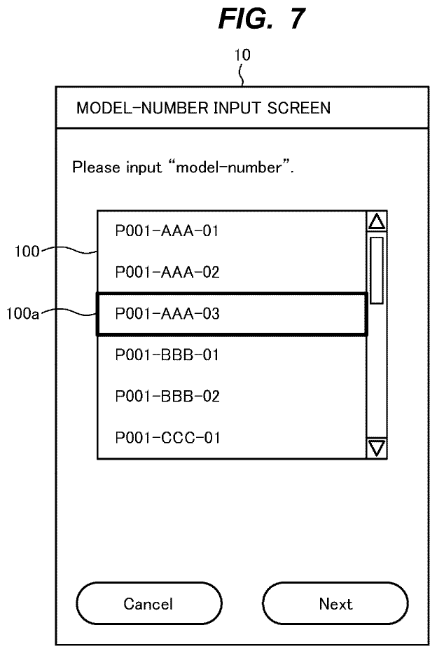

The performance-characteristic acquisition section 300 may acquire at least the flow-rate vs. total-pump-head typical performance curve (QH_{typical}(Q)) in the rated operation and the rated rotational speed (N_{rated}) as the performance characteristics of the support target device specified by the model number (Mn) of the pump device 2, and may further acquire the flow-rate vs. power-consumption typical performance curve (QW typical (Q)) in the rated operation and the number of motor poles (PoleCount). For example, the performance-characteristic acquisition section 300 may generate model-number input screen information into which the model number (Mn) can be input, and may acquire the performance characteristics based on the model number (Mn) that has been input to a model-number input screen (see FIG. 7 described later) based on the model-number input screen information. Specifically, the performance-characteristic acquisition section 300 may transmit a data-transmission request including the model number (Mn) to the pump database device 4 and may acquire the performance characteristics of the support target device from the pump database device 4 in response to the data-transmission request. Furthermore, when the pump database 40 is stored in the memory section 32, the performance-characteristic acquisition section 300 may acquire the performance characteristics of the support target device by referring to the pump database 40 based on the model number. It is noted that when data on the performance characteristics of the support target device is stored in the pump controller 22 of the support target device itself, the performance-characteristic acquisition section 300 may transmit a data-transmission request for the performance characteristics to the pump device 2 as the support target device, and may acquire the performance characteristics of the support target device from the pump device 2 in response to the data-transmission request. In that case, the user input of the model number may be omitted.

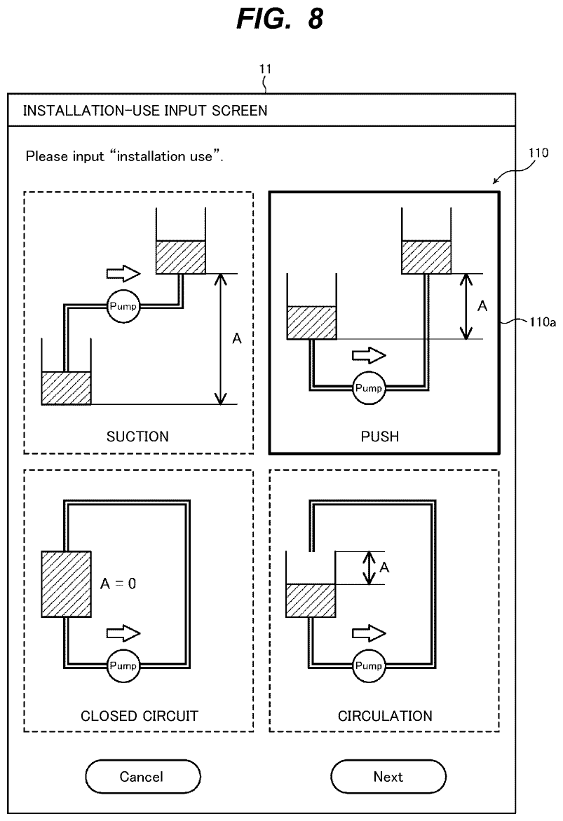

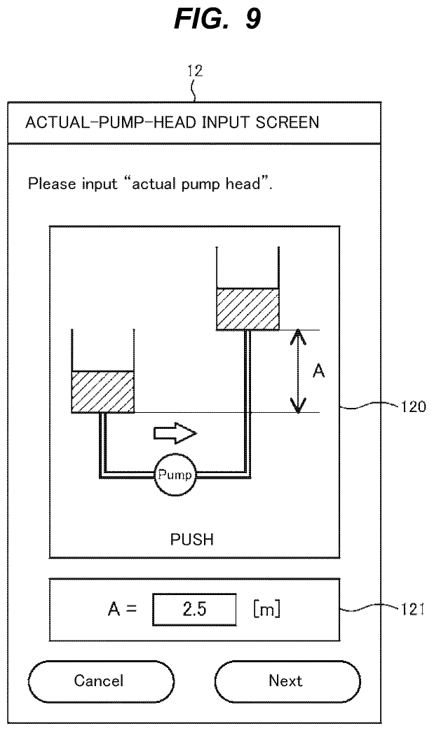

The installation-state acquisition section 301 may acquire at least actual pump head (H_{static}) as the installation state in which the support target device is installed, and may further acquire installation use (Use). For example, the installation-state acquisition section 301 generates installation-state input screen information into which the installation state of the pump device 2 as the support target device can be input, and acquires the installation state of the support target device by accepting user input via an installation-state input screen (see FIG. 8 and FIG. 9 described later) based on the installation-state input screen information. It is noted that, when the data of the installation state of the support target device is stored in the pump controller 22 of the support target device, the installation-state acquisition section 301 may transmit a data-transmission request for the installation state to the pump device 2 as the support target device, and may acquire the installation state of the support target device from the pump device 2 in response to the data-transmission request. Furthermore, when the data of the installation state of the support target device is stored in the memory section 32 or an external storage device or storage medium, the installation-state acquisition section 301 may acquire the installation state of the support target device by referring to the data.

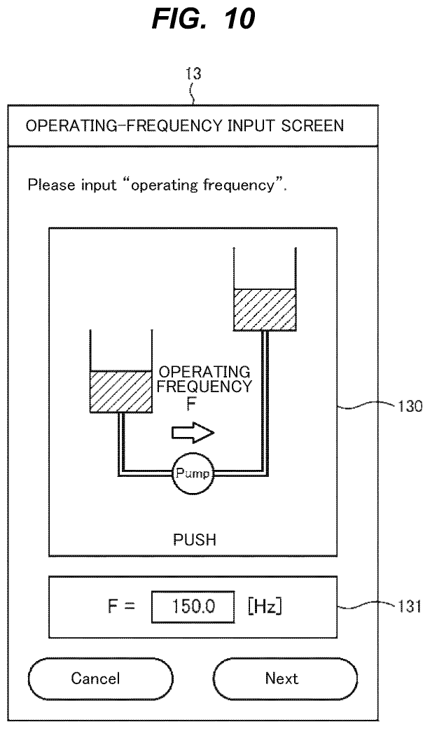

The operation-state acquisition section 302 may acquire at least operating frequency (Fₒᵤₜ), suction pressure (P_{suction}), and discharge pressure (P_{discharge}) as the operation state of the support target device when the support target device is operated in the installation state, and may further acquire a measurement-point-height difference (H_{diff}). For example, the operation-state acquisition section 302 generates operation-state input screen information into which the operation state of the pump device 2 as the support target device can be input, and acquires the operation state of the support target device by accepting user input via an operation-state input screen (see FIGS. 10 to 12 described later) based on the operation-state input screen information. It is noted that, when data on the operation state of the support target device is stored in the pump controller 22 of the support target device, the operation-state acquisition section 302 may transmit a data-transmission request for the operation state to the pump device 2 as the support target device, and may acquire the operation state of the support target device from the pump device 2 in response to the data-transmission request. In addition, when data on the operation state of the support target device is stored in the memory section 32 or an external storage device or storage medium, the operation-state acquisition section 302 may acquire the operation state of the support target device by referring to that data.

The first operation support section 303 performs a first operation support process to calculate the operating conditions in the reference operation of the support target device when the support target device is operated in the installation state and the operation state. At that time, the first operation support section 303 calculates the operating conditions in the reference operation based on the performance characteristics, the installation state, and the operation state, and stores the calculation results of various data as the operation-support internal data 322. The operating conditions in the reference operation include, for example, flow rate (Q_{now}), total pump head (H_{now}), and energy-saving rate (ESR_{now}) in the reference operation. The time of the reference operation corresponds to a time when the support target device is operated in the installation state and the operation state, but may be a current time or a past time. In addition, the time of the reference operation may be, for example, a situation when a test operation is performed during installation, inspection, repair, etc. of the pump device 2, or a situation when normal operation is performed.

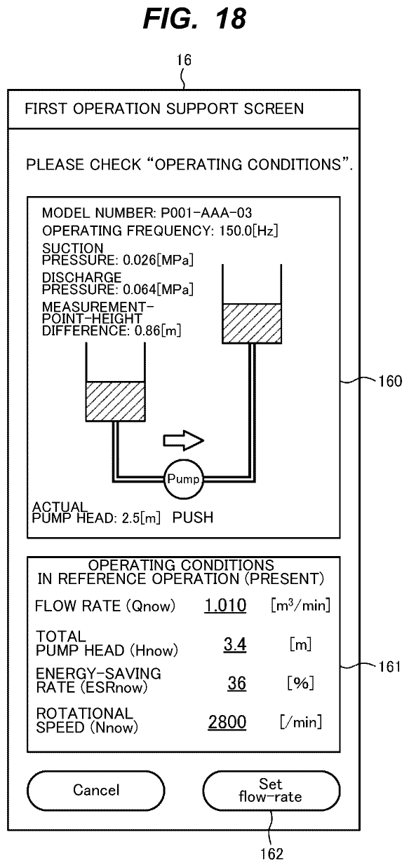

The first operation support section 303 further functions as a user interface for the first operation support process. For example, the first operation support section 303 generates first operation support screen information that displays calculation results of operating conditions in a reference flow-rate operation calculated by the first operation support process, and displays a first operation support screen (see FIG. 18 described later) based on the first operation support screen information.

When the second operation support section 304 receives an input of a set flow rate (Qₛₑₜ) as a flow rate at which the support target device is operated in the installation state, the second operation support section 304 performs a second operation support process to calculate operating conditions for the set flow-rate operation of the support target device when the support target device is operated in the installation state and at the set flow rate, and stores the calculation results of various data as the operation-support internal data 322. The operating conditions for the set flow-rate operation include, for example, command frequency (F_{cmdset}) in the set flow-rate operation, total pump head (Hₛₑₜ) and energy-saving rate (ESRₛₑₜ) for the set flow-rate operation.

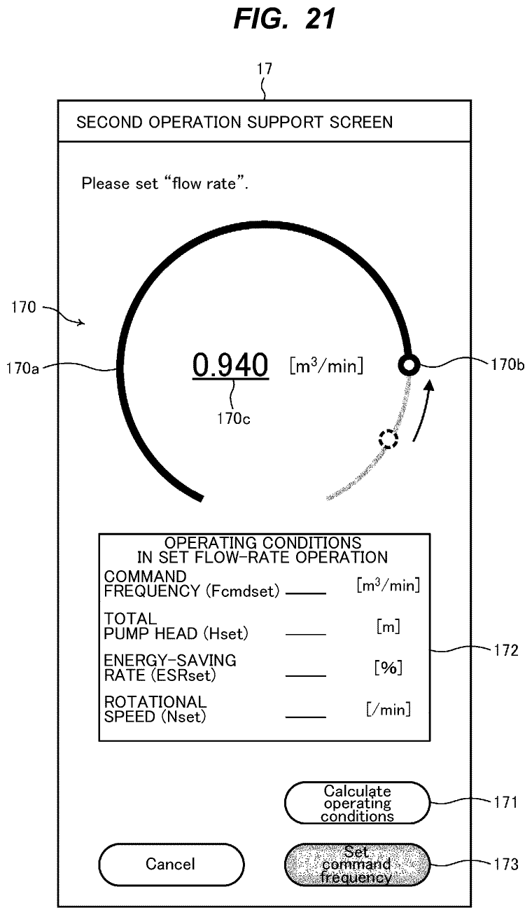

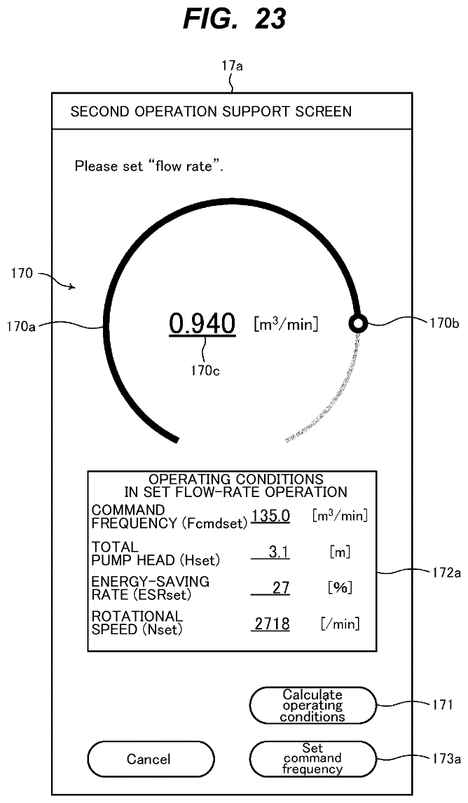

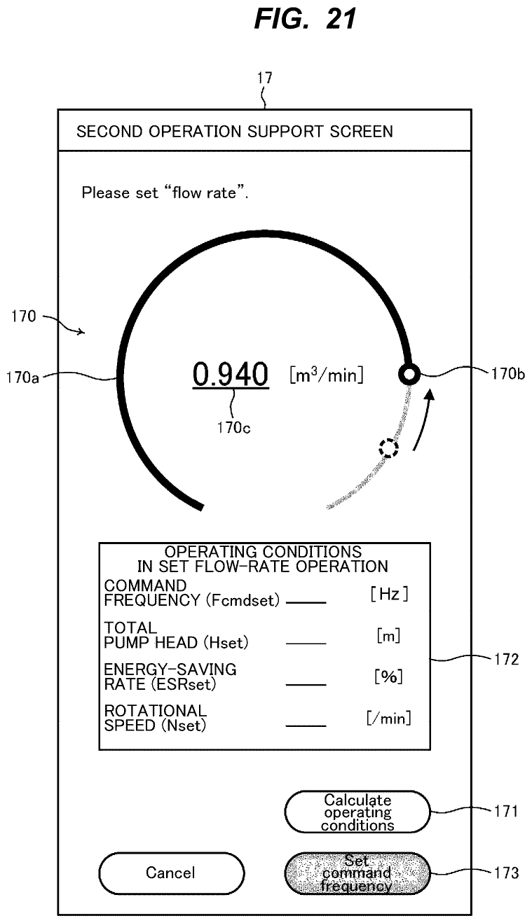

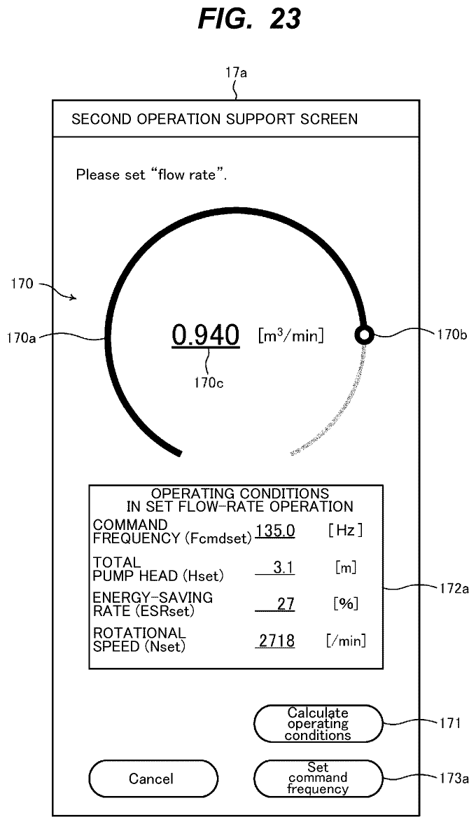

The second operation support section 304 further functions as a user interface for the second operation support process. For example, the second operation support section 304 generates second operation support screen information including a set flow-rate input section capable of inputting a set flow rate (Qₛₑₜ), a second calculation-result display section that displays a calculation result of operating conditions in set flow-rate operation calculated by the second operation support process based on the set flow rate (Qₛₑₜ) input by the set flow-rate input section, and a command-frequency setting instruction section capable of inputting a setting instruction to set the command frequency (F_{cmdset}) in the set flow-rate operation to the support target device. The command frequency (F_{cmdset}) serves as the operating conditions in the set flow-rate operation calculated by the second operation support process. The second operation support section 304 displays a second operation support screen (see FIG. 21 and FIG. 23 described later) based on the second operation support screen information.

FIG. 5 is a hardware configuration diagram showing an example of a computer 900 constituting each device.

Each of the pump device 2, the pump-operation support apparatus 3, and the pump database device 4 is configured by a general-purpose or dedicated computer 900. As shown in FIG. 3, main components of the computer 900 include buses 910, a processor 912, a memory 914, an input device 916, an output device 917, a display device 918, a storage device 920, a communication I/F (interface) section 922, an external device I/F section 924, an I/O (input/output) device I/F section 926, and a media input/output section 928. The above components may be omitted as appropriate depending on an application in which the computer 900 is used.

The processor 912 includes one or more arithmetic processing unit(s) (CPU (Central Processing Unit), MPU (Micro-processing unit), DSP (digital signal processor), GPU (Graphics Processing Unit), etc.), and operates as a controller configured to control the entire computer 900. The memory 914 stores various data and programs 930, and includes, for example, a volatile memory (DRAM, SRAM, etc.) that functions as a main memory, a non-volatile memory (ROM), a flash memory, etc.

The input device 916 includes, for example, a keyboard, a mouse, a numeric keypad, an electronic pen, etc., and functions as an input section. The output device 917 includes, for example, a sound (voice) output device, a vibration device, etc., and functions as an output section. The display device 918 includes, for example, a liquid crystal display, an organic EL display, electronic paper, a projector, etc., and functions as an output section. The input device 916 and the display device 918 may be configured integrally, such as a touch panel display. The storage device 920 includes, for example, HDD (Hard Disk Drive), SSD, etc., and functions as a storage section. The storage device 920 stores various data necessary for executing the operating system and the programs 930.

The communication I/F section 922 is coupled to a network 940, such as the Internet or an intranet (which may be the same as the network 5 in FIG. 1), in a wired manner or a wireless manner, and transmits and receives data to and from another computer according to a predetermined communication standard. The communication I/F section 922 functions as a communication unit that sends and receives information. The external device I/F section 924 is coupled to an external device 950, such as camera, printer, scanner, reader/writer, etc. in a wired manner or a wireless manner, and serves as a communication section that transmits and receives data to and from the external device 950 according to a predetermined communication standard. The I/O device I/F unit 926 is coupled to I/O devices 960, such as various sensors or actuators, and functions as a communication unit that transmits and receives various signals, such as detection signals from the sensors or control signals to the actuators, and data to and from the I/O devices 960. The media input/output unit 928 is constituted of a drive device, such as a DVD (Digital Versatile Disc) drive or a CD (Compact Disc) drive, a memory card slot, or a USB connector, and writes and reads data into and from medium (non-transitory storage medium) 970, such as a DVD, a CD, a memory card, or a USB memory.

In the computer 900 having the above configurations, the processor 912 calls the program 930 stored in the storage device 920 into the memory 914 and executes the program 930, and controls each part of the computer 900 via the buses 910. The program 930 may be stored in the memory 914 instead of the storage device 920. The program 930 may be stored in the medium 970 in an installable file format or an executable file format, and may be provided to the computer 900 via the media input/output unit 928. The program 930 may be provided to the computer 900 by being downloaded via the network 940 and the communication I/F unit 922. The computer 900 performs various functions realized by the processor 912 executing the programs 930. The computer 900 may include hardware, such an FPGA (field-programmable gate array), an ASIC (application specific integrated circuit), etc. for executing the above-described various functions.

The computer 900 is, for example, a stationary computer or a portable computer, and is an electronic device in arbitrary form. The computer 900 may be a client computer, a server computer, or a cloud computer.

### (Pump-Operation Support Method)

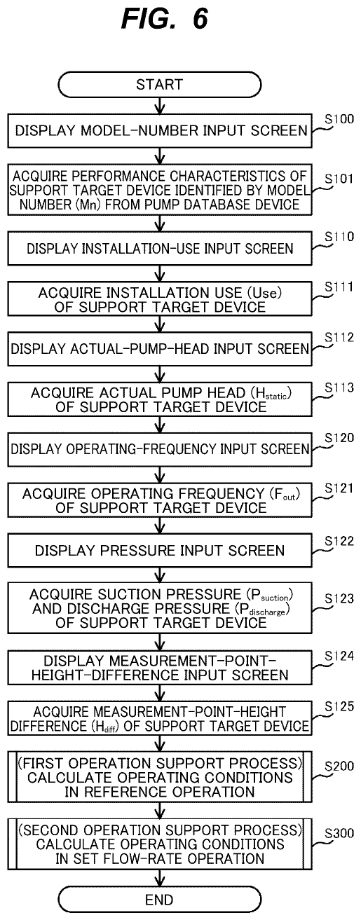

FIG. 6 is a flowchart showing an example of a pump-operation support method performed by the pump-operation support apparatus 3. The following describes a case where an installer (user) of the pump device 2, which is the support target device, starts the pump-operation support program 320 (smartphone application) installed on a smartphone functioning as the pump-operation support apparatus 3 in order to check or set the operating conditions of the pump device 2 when performing a test operation after installing of the pump device 2.

First, in step S100, the performance-characteristic acquisition section 300 generates model-number input screen information in response to the start of the pump-operation support program 320, and displays a model-number input screen 10 on the output section 34 based on the model-number input screen information.

FIG. 7 is a diagram showing an example of the model-number input screen 10. The model-number input screen 10 has, for example, a model-number input section 100 that displays model numbers (Mn) of the pump device 2 in a list format and is capable of accepting an input of a model number (Mn) of the pump device 2 by the user. The list of the model numbers (Mn) displayed in the model-number input section 100 may be provided by, for example, the pump database device 4 or may be stored in the memory section 32. The model-number input section 100 may be capable of accepting an input of a character string. FIG. 7 shows a case where “P001-AAA-03” is selected as the model number (Mn) of the pump device 2 with a selection frame 100a.

In step S101, when the performance-characteristic acquisition section 300 accepts the user input of the model number (Mn) (in this example, “P001-AAA-03”) of the support target device on the model-number input screen 10, the performance-characteristic acquisition section 300 then transmits a data-transmission request including the model number (Mn) to the pump database device 4, and acquires performance characteristics of the support target device identified by the model number (Mn) as a response to the data-transmission request. In this embodiment, the performance-characteristic acquisition section 300 acquires the performance characteristics of the support target device including a flow-rate vs. total-pump-head typical performance curve (QH_{typical}(Q)) in a rated operation, a flow-rate vs. power-consumption typical performance curve (QW_{typical}(Q)) in the rated operation, a rated rotational speed (N_{rated}), and the number of motor poles (PoleCount).

Next, in step S110, the installation-state acquisition section 301 generates installation-use input screen information, and displays an installation-use input screen 11 on the output section 34 based on the installation-use input screen information.

FIG. 8 is a diagram showing an example of the installation-use input screen 11. The installation-use input screen 11 has, for example, an installation-use input section 110 that displays installation uses (Use) of the pump device 2 in schematic diagrams. The installation-use input section 110 is capable of accepting an input of installation use (Use) of the pump device 2 by the user. In FIG. 8, four installation uses (Use) of the pump device 2, “suction”, “push”, “closed circuit”, and “circulation”, are shown as examples, while installation uses (Use) other than these examples may be included. FIG. 8 shows a case where “push” is selected as the installation use (Use) of the pump device 2 with a selection frame 110a.

In step S111, the installation-state acquisition section 301 then acquires the installation use (Use) of the support target device by accepting the user input of the installation use (Use) (in this example, “push”) on the installation-use input screen 11.

Next, in step S112, the installation-state acquisition section 301 generates actual-pump-head input screen information according to the installation use (Use) of the support target device, and displays an actual-pump-head input screen 12 on the output section 34 based on the actual-pump-head input screen information.

FIG. 9 is a diagram showing an example of the actual-pump-head input screen 12. The actual-pump-head input screen 12 has, for example, an installation-use display section 120 that displays the installation use (Use) of the pump device 2 (in this example, “push”), and an actual-pump-head input section 121 that is capable of accepting an input of the actual pump head (H_{static}) by the user. FIG. 9 shows a case where “2.5” is input as the actual pump head (H_{static}).

In step S113, the installation-state acquisition section 301 then acquires the actual pump head (H_{static}) of the support target device by accepting the user input of the actual pump head (H_{static}) on the actual-pump-head input screen 12.

Next, in step S120, the operation-state acquisition section 302 generates operating-frequency input screen information, and displays an operating-frequency input screen 13 on the output section 34 based on the operating-frequency input screen information.

FIG. 10 is a diagram showing an example of the operating-frequency input screen 13. The operating-frequency input screen 13 has, for example, an installation-use display section 130 that displays the installation use (Use) of the pump device 2 (in this example, “push”), and an operating-frequency input section 131 that is capable of accepting an input of operating frequency (Fₒᵤₜ) by the user. In this embodiment, the operation-state acquisition section 302 transmits a data-transmission request for the operating frequency (Fₒᵤₜ) to the support target device (the pump device 2 that has performed a test operation) when the operation-state acquisition section 302 is generating the operating-frequency input screen information. The operation-state acquisition section 302 acquires the operating frequency (Fₒᵤₜ) of the support target device (in this example, “150.0”) as a response to the data-transmission request. The operation-state acquisition section 302 then inputs the result of acquiring the operating frequency (Fₒᵤₜ) as a default value of the operating-frequency input section 131, and displays the default value on the operating-frequency input screen 13. The operating-frequency input section 131 may be capable of accepting input (change) of the numerical value.

In step S121, the operation-state acquisition section 302 then acquires the operating frequency (Fₒᵤₜ) of the support target device by accepting the user input of the operating frequency (Fₒᵤₜ) (in this example, “150.0” received from the support target device) on the operating-frequency input screen 13.

Next, in step S122, the operation-state acquisition section 302 generates pressure input screen information, and displays a pressure input screen 14 on the output section 34 based on the pressure input screen information.

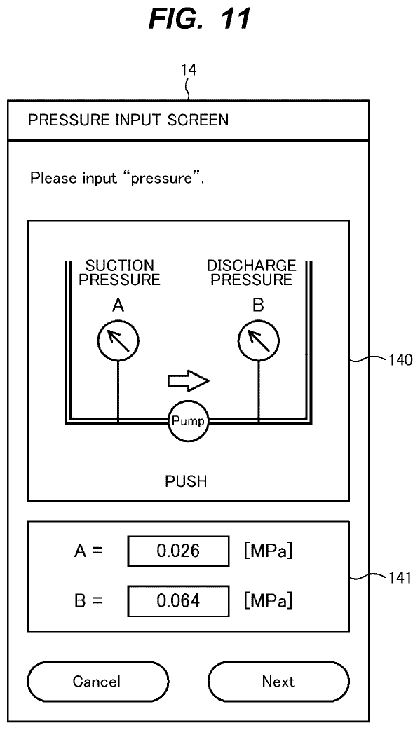

FIG. 11 is a diagram showing an example of the pressure input screen 14. The pressure input screen 14 has, for example, an installation-use display section 140 that displays the installation use (Use) of the pump device 2 (in this example, “push”), and a pressure input section 141 that is capable of accepting inputs of suction pressure (P_{suction}) and the discharge pressure (P_{discharge}) by the user. FIG. 11 shows a case where “0.026” and “0.064” are input as the suction pressure (P_{suction}) and the discharge pressure (P_{discharge}), respectively. In this embodiment, the values that have been input in the pressure input section 141 are results of visually reading a pressure value indicated by a suction-side pressure meter and a pressure value indicated by a discharge-side pressure meter by the user when the pump device 2 is actually operating during a test operation.

In step S123, the operation-state acquisition section 302 then acquires the suction pressure (P_{suction}) and the discharge pressure (P_{discharge}) of the support target device by accepting the user inputs of the suction pressure (P_{suction}) and the discharge pressure (P_{discharge}) on the pressure input screen 14.

Next, in step S124, the operation-state acquisition section 302 generates measurement-point-height-difference input screen information, and displays a measurement-point-height-difference input screen 15 on the output section 34 based on the measurement-point-height-difference input screen information.

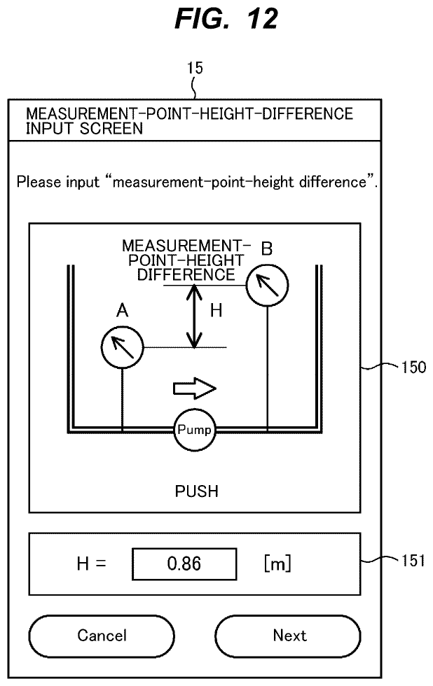

FIG. 12 is a diagram showing an example of the measurement-point-height-difference input screen 15. The measurement-point-height-difference input screen 15 has, for example, an installation-use display section 150 that displays the installation use (Use) of the pump device 2 (in this example, “push”), and a measurement-point-height-difference input section 151 that is capable of accepting an input of a measurement-point-height difference (H_{diff}) by the user. FIG. 12 shows a case where “0.86” is input as the measurement-point-height difference (H_{diff}).

In step S125, the operation-state acquisition section 302 then acquires the measurement-point-height difference (H_{diff}) of the support target device by accepting the user input of the measurement-point-height difference (H_{diff}) on the measurement-point-height-difference input screen 15. The operation-state acquisition section 302 may calculate the measurement-point-height difference (H_{diff}) using the following formula (1) by accepting user inputs of a suction-side instrument height (GH_{suction}) and a discharge-side instrument height (GH_{discharge}) on the measurement-point-height-difference input screen 15.

$$\begin{matrix}[ Math . 1 ] & \\ {H}_{diff} = {GH}_{suction} - {GH}_{discharge} & ( 1 )\end{matrix}$$

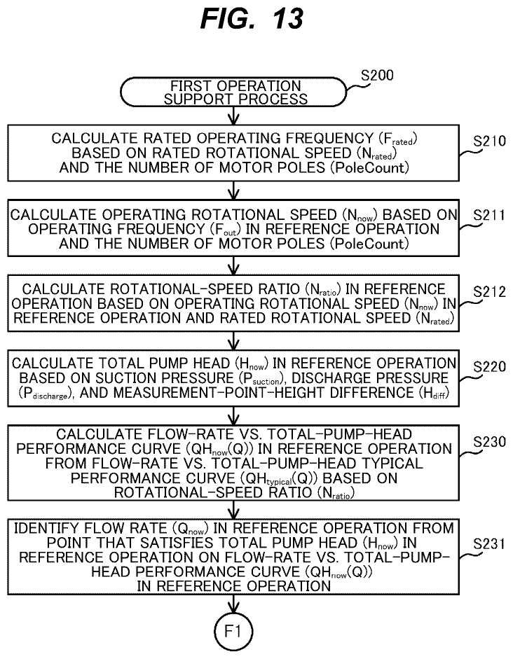

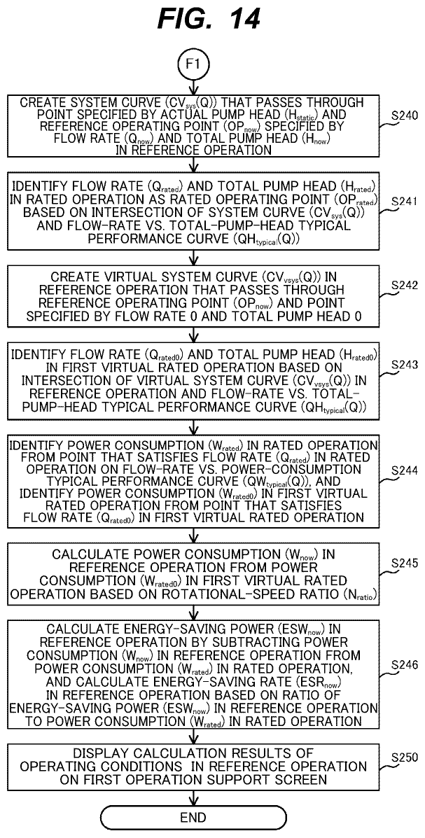

Next, in step S200, the first operation support section 303 calculate operating conditions in a reference operation by performing a first operation support process shown in FIGS. 13 and 14 described later, based on the performance characteristics acquired in the steps S100 to S101, the installation state acquired in the steps S110 to S113, and the operation state acquired in the steps S120 to S125. Details of the first operation support process will be described below.

FIGS. 13 and 14 are flowcharts showing an example of the first operation support process (step S200) performed by the first operation support section 303.

First, in step S210, the first operation support section 303 calculates a rated operating frequency (F_{rated}) corresponding to the rated rotational speed (N_{rated}) based on the rated rotational speed (N_{rated}) and the number of motor poles (PoleCount) using the following formula (2).

$$\begin{matrix}[ Math . 2 ] & \\ {F}_{rated} = {N}_{rated} \cdot PoleCount / 120 & ( 2 )\end{matrix}$$

Next, in step S211, an operating rotational speed (N_{now}) corresponding to the operating frequency (Fₒᵤₜ) in the reference operation is calculated based on the operating frequency (Fₒᵤₜ) in the reference operation and the number of motor poles (PoleCount) by the following formula (3).

$$\begin{matrix}[ Math . 3 ] & \\ {N}_{now} = 120 \cdot {F}_{out} / PoleCount & ( 3 )\end{matrix}$$

Next, in step S212, a rotational-speed ratio (Nᵣₐₜᵢₒ) in the reference operation is calculated based on the operating rotational speed (N_{now}) in the reference operation and the rated rotational speed (N_{rated}) by the following formula (4).

$$\begin{matrix}[ Math . 4 ] & \\ {N}_{ratio} = {N}_{n o w} / {N}_{r a t e d} & ( 4 )\end{matrix}$$

Next, in step S220, total pump head (H_{now}) in the reference operation is calculated based on the suction pressure (P_{suction}), the discharge pressure (P_{discharge}), and the measurement-point-height difference (H_{diff}) by the following formula (5).

$$\begin{matrix}[ Math . 5 ] & \\ {H}_{now} = k \cdot ( {P}_{suction} - {P}_{discharge} ) + {H}_{diff} & ( 5 )\end{matrix}$$

where k is a coefficient (~102) for converting a unit of pressure [MPa] to a unit of pump head “m”.

Next, in step S230, the flow-rate vs. total-pump-head performance curve (QH_{now}(Q)) in the reference operation is calculated from the flow-rate vs. total-pump-head typical performance curve (QH_{typical}(Q)) based on the rotational-speed ratio (Nᵣₐₜᵢₒ) between the operating rotational speed (N_{now}) in the reference operation and the rated rotational speed (N_{rated}). For example, the flow-rate vs. total-pump-head performance curve (QH_{now}(Q)) in the reference operation is calculated by converting the flow-rate vs. total-pump-head typical performance curve (QH_{typical}(Q)) expressed by the following formula (6) to the following formula (7) and calculating coefficients (aₕₕ, bₕₕ, cₕₕ).

$$\begin{matrix}[ Math . 6 ] & \\ {QH}_{typical} ( Q ) = {a}_{ht} \cdot {Q}^{2} + {b}_{ht} \cdot Q + {c}_{ht} & ( 6 )\end{matrix}$$

$$\begin{matrix}[ Math . 7 ] & \\ {QH}_{now} ( Q ) = {a}_{ht} \cdot {Q}^{2} \cdot {N}_{ratio} + {b}_{ht} \cdot Q + {c}_{ht} \cdot {{N}_{ratio}}^{2} = {a}_{hh} \cdot {Q}^{2} + {b}_{hh} \cdot Q + {c}_{hh} & ( 7 )\end{matrix}$$

In step S231, flow rate (Q_{now}) in the reference operation is then identified from a point that satisfies the total pump head (H_{now}) in the reference operation on the flow-rate vs. total-pump-head performance curve (QH_{now}(Q)) in the reference operation.

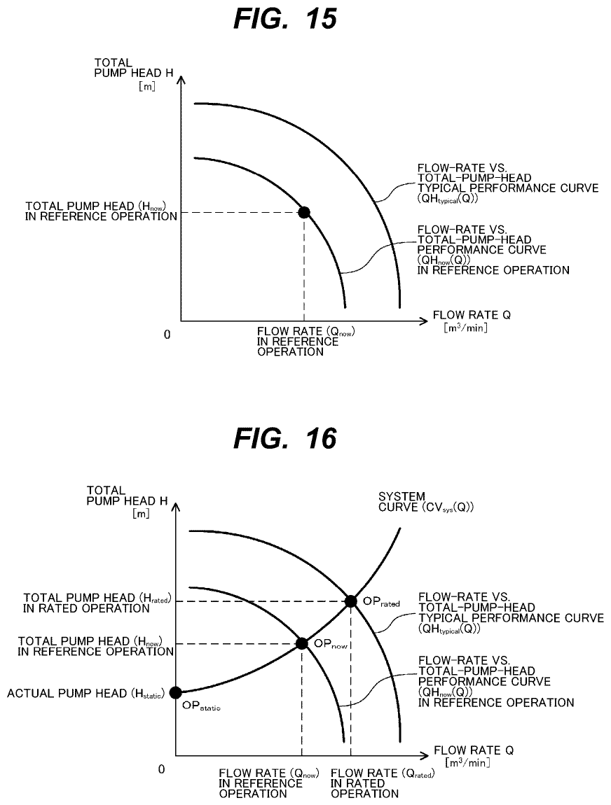

FIG. 15 is a graph showing the flow-rate vs. total-pump-head performance curve (QH_{now}(Q)) in the reference operation, and an example of calculation of the total pump head (H_{now}) in the reference operation and the flow rate (Q_{now}) in the reference operation. The flow-rate vs. total-pump-head performance curve (QH_{now}(Q)) in the reference operation is calculated in the step S230 from the flow-rate vs. total-pump-head typical performance curve (QH_{typical}(Q)). The flow rate (Q_{now}) in the reference operation is identified, in the step S231, by substituting the total pump head (H_{now}) in the reference operation calculated in the step S220 into the flow-rate vs. total-pump-head performance curve (QH_{now}(Q)) in the reference operation.

Next, in step S240, a system curve (CV_{sys}(Q)) is created that passes through a point (OP static) specified by the actual pump head (H_{static}) and a reference operating point (OP_{now}) specified by the flow rate (Q_{now}) and the total pump head (H_{now}) in the reference operation in a relationship between flow rate and total pump head (see FIG. 16 described later). The system curve (CV_{sys}(Q)) is approximated as a quadratic curve by, for example, the following formula (8).

$$\begin{matrix}[ Math . 8 ] & \\ {CV}_{sys} ( Q ) = {a}_{s} \cdot {Q}^{2} \cdot {b}_{s} & ( 8 )\end{matrix}$$

Next, in step S241, flow rate (Q_{rated}) and total pump head (H_{rated}) in the rated operation are identified as a rated operating point (OP_{rated}) based on an intersection of the system curve (CV_{sys}(Q)) and the flow-rate vs. total-pump-head typical performance curve (QH_{typical}(Q)).

FIG. 16 is a graph showing an example of calculation of the system curve (CV_{sys}(Q)) and the flow rate (Q_{rated}) and the total pump head (H_{rated}) in the rated operation.

The system curve (CV_{sys}(Q)) is created in the step S240 as a quadratic curve that passes through the point (OP_{static}) and the reference operating point (OP_{now}). The rated operating point (OP_{rated}) is identified in the step S241 as the intersection of the system curve (CV_{sys}(Q)) and the flow-rate vs. total-pump-head typical performance curve (QH_{typical}(Q)).

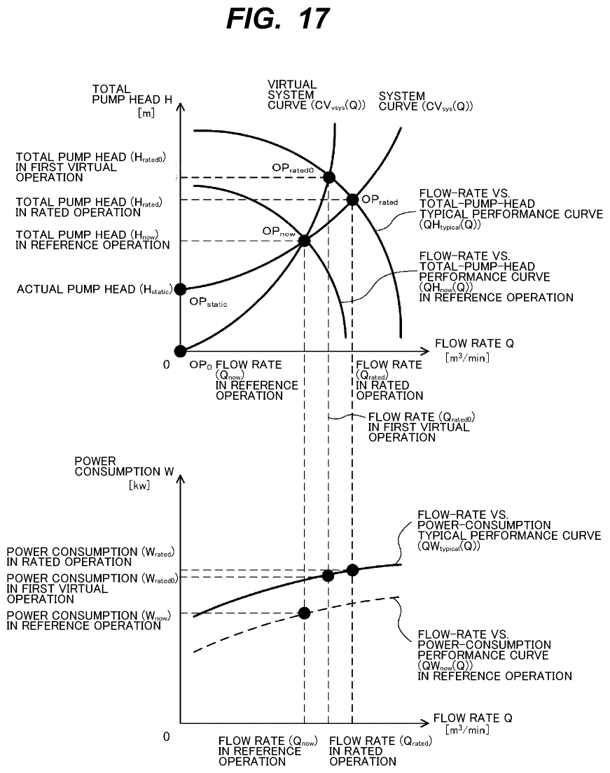

Next, in step S242, a virtual system curve (CV_{vsys}(Q)) in the reference operation is created that passes through the reference operating point (OP_{now}) and a point (OP₀) specified by flow rate of 0 and total pump head of 0 in a relationship between flow rate and total pump head (see FIG. 17 described later).

Next, in step S243, flow rate (Q_{rated0}) and total pump head (H_{rated0}) in a first virtual rated operation corresponding to the rated operation in a virtual state in which actual pump head in the reference operation is 0 are identified as a first virtual rated operating point (OP_{rated0}) based on an intersection of the virtual system curve (CV_{vsys}(Q)) in the reference operation and the flow-rate vs. total-pump-head typical performance curve (QH_{typical}(Q))

Next, in step S244, power consumption (W_{rated}) in the rated operation is identified from a point that satisfies flow rate (Q_{rated}) in the rated operation on the flow-rate vs. power-consumption typical performance curve (QW_{typical}(Q)), and power consumption (W_{rated0}) in the first virtual rated operation is identified from a point that satisfies the flow rate (Q_{rated0}) in the first virtual rated operation.

Next, in step S245, power consumption (W_{now}) in the reference operation is calculated from the power consumption (W_{rated0}) in the first virtual rated operation based on a rotational-speed ratio (Nᵣₐₜᵢₒ) between the operating rotational speed (N_{now}) in the reference operation and the rated rotational speed (N_{rated}) by the following formula (9).

$$\begin{matrix}[ Math . 9 ] & \\ {W}_{now} = {W}_{rated 0} \cdot {( {N}_{ratio} )}^{3} & ( 9 )\end{matrix}$$

Next, in step S246, energy-saving power (ESW_{now}) in the reference operation is calculated by subtracting the power consumption (W_{now}) in the reference operation from the power consumption (W_{rated}) in the rated operation by the following formula (10), and an energy-saving rate (ESR_{now}) in the reference operation is calculated based on a ratio of the energy-saving power (ESW_{now}) in the reference operation to the power consumption (W_{rated}) in the rated operation by the following formula (11).

$$\begin{matrix}[ Math . 10 ] & \\ {ESW}_{now} = {W}_{rated} - {W}_{now} & ( 10 )\end{matrix}$$

$$\begin{matrix}[ Math . 11 ] & \\ {ESR}_{now} = ( {ESW}_{now} / {W}_{rated} ) \cdot 100 & ( 11 )\end{matrix}$$

FIG. 17 is a graph showing a relationship between flow rate and total pump head in the reference operation, and a relationship between flow rate and power consumption. The virtual system curve (CV_{vsys}(Q)) in the reference operation is created in the step S242 as a quadratic curve that passes through the point (OP₀) and the reference operating point (OP_{now}). The first virtual rated operating point (OP_{rated0}) is identified in the step S243 as the intersection of the virtual system curve (CV_{vsys}(Q)) in the reference operation and the flow-rate vs. total-pump-head typical performance curve (QH_{typical}(Q)). The power consumption (W_{rated}) in the rated operation and the power consumption (W_{rated0}) in the first virtual rated operation are identified in the step S244 by substituting each of the flow rate (Q_{rated}) in the rated operation and the flow rate (Q_{rated0}) in the first virtual rated operation into the flow-rate vs. power-consumption typical performance curve (QW_{typical}(Q)). The power consumption (W_{now}) in the reference operation is calculated in the step S245 by multiplying the power consumption (W_{rated0}) in the first virtual rated operation by the cube of the rotational-speed ratio (Nᵣₐₜᵢₒ). It is noted that a flow-rate vs. power-consumption performance curve (QW_{now}(Q)) in the reference operation shown by a dashed line in FIG. 17 is not calculated as a quadratic curve, but is shown for reference.

In step S250, the first operation support section 303 then generates first operation support screen information that displays calculation results of the operating conditions in the reference operation as results of performing the first operation support process as described above, and displays a first operation support screen 16 on the output section 34 based on the first operation support screen information.

FIG. 18 is a diagram showing an example of the first operation support screen 16. The first operation support screen 16 has, for example, an input-content display section 160 that displays the input contents input on the screens 10 to 15, a first calculation-result display section 161 that displays the calculation result of the operating conditions in the reference operation calculated by the first operation support process, and a flow-rate setting button 162 capable of inputting a display instruction of the second operation support screen 17 (see FIG. 21 and FIG. 23 described later) for setting flow rate of the support target device. The first calculation-result display section 161 displays, for example, the flow rate (Q_{now}), the total pump head (H_{now}), the energy-saving rate (ESR_{now}), and the operating rotational speed (N_{now}) as the operating conditions in the reference operation. The first calculation-result display section 161 may display other data as long as the data has been stored in the operation-support internal data 322 in the first operation support process.

As described above, the pump-operation support apparatus 3 and the pump-operation support method according to the present embodiment can calculate (estimate) the flow rate (Q_{now}) and the total pump head (H_{now}) when the support target device having specific performance characteristics is operated under specific installation state and operation state by performing the first operation support process, so that operation support of the pump device 2 can be easily performed without using a flow meter for the support target device. In addition, since the energy-saving rate (ESR_{now}) when the support target device is operated is calculated, energy saving effect when the support target device is operated at the specific operating frequency (Fₒᵤₜ) can be checked without using, for example, a watt-hour meter or the like, for the support target device.

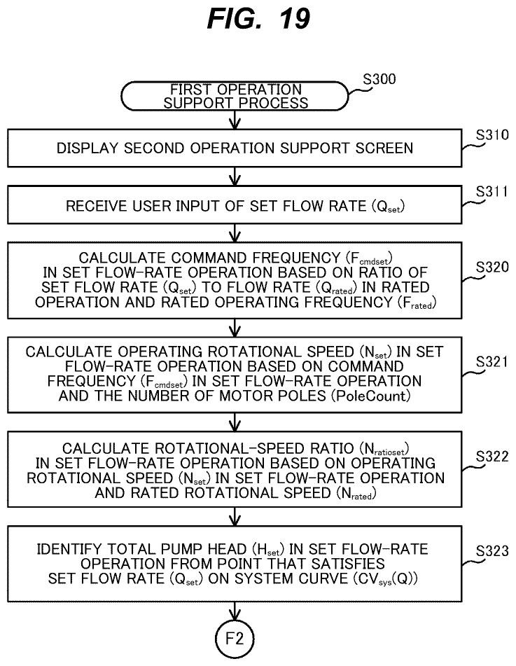

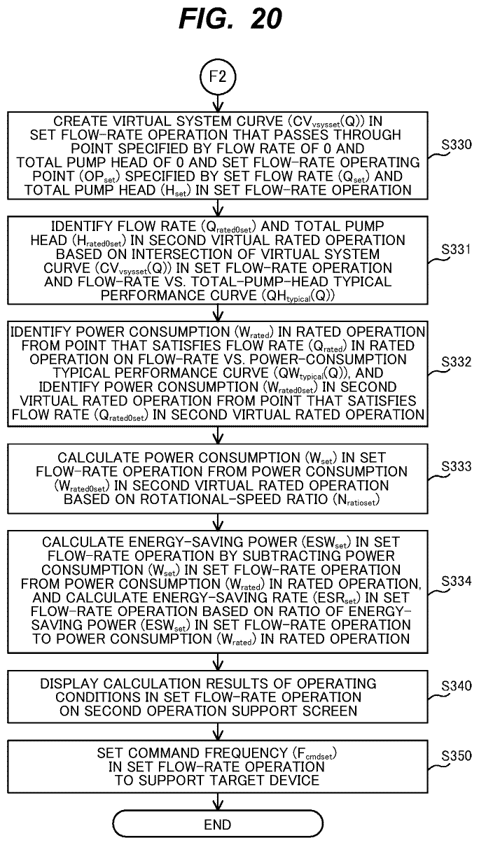

Referring back to FIG. 6, in step S300, the second operation support section 304 displays the second operation support screen 17 (see FIGS. 21 and 23 described later) in response to pressing of the flow-rate setting button 162 on the first operation support screen 16. The second operation support section 304 receives an input of a set flow rate (Qₛₑₜ) on the second operation support screen 17 as a flow rate at which the support target device is operated in the installation state, and calculates operating conditions in the set flow-rate operation by performing steps shown in FIGS. 19 and 20 described later as the second operation support process. Details of the second operation support process will be described below.

FIGS. 19 and 20 are flowcharts showing an example of the second operation support process (step S300) performed by the second operation support section 304.

First, in step S310, the second operation support section 304 generates second operation support screen information in response to pressing of the flow-rate setting button 162 on the first operation support screen 16, and displays the second operation support screen 17 on the output section 34 based on the second operation support screen information.

FIG. 21 is a diagram showing an example of the second operation support screen 17. The second operation support screen 17 has a set flow-rate input section 170 capable of inputting a set flow rate (Qₛₑₜ) that can be changed stepwise or continuously, an operating-condition calculating button 171 capable of inputting a performing instruction to perform the second operation support process that calculates operating conditions in the set flow-rate operation based on the set flow rate (Qₛₑₜ) input by the set flow-rate input section 170, a second calculation-result display section 172 that displays a calculation result of the operating conditions in the set flow-rate operation calculated by the second operation support process, and a command-frequency setting button 173 capable of inputting a setting instruction to set the command frequency (F_{cmdset}) in the set flow-rate operation to the support target device. The command frequency (F_{cmdset}) serves as the operating conditions in the set flow-rate operation calculated by the second operation support process.

The set flow-rate input section 170 is configured to input the set flow rate (Qₛₑₜ) by sliding a pointer 170b along an arc 170a. FIG. 23 shows a case where the set flow rate (Qₛₑₜ) is changed from “1.010” of the flow rate (Q_{now}) in the reference operation to “0.940” of an input flow rate as shown in a flow rate 170c. In FIG. 21, since the second operation support process has not yet been performed, the second calculation-result display section 172 does not display the calculation result, and the command-frequency setting button 173 is displayed in a manner such that the command-frequency setting button 173 cannot be pressed (grayed out). The operating-condition calculating button 171 may be omitted. In that case, the second operation support section 304 may calculate the operating conditions in the set flow-rate operation in response to input of the set flow rate (Qₛₑₜ) on the set flow-rate input section 170.

In step S311, the second operation support section 304 then receives the user input of the set flow rate (Qₛₑₜ) (in this example, “0.940”) set in the set flow-rate input section 170 in response to pressing of the operating-condition calculating button 171 on the second operation support screen 17.

Next, in step S320, the command frequency (F_{cmdset}) in the set flow-rate operation is calculated based on a ratio of the set flow rate (Qₛₑₜ) to the flow rate (Q_{rated}) in the rated operation and the rated operating frequency (F_{rated}) corresponding to the rated rotational speed (N_{rated}) by the following formula (12). At that time, the second operation support section 304 may calculate the rated operating frequency (F_{rated}), create the system curve (CV_{sys}(Q)), and specify the flow rate (Q_{rated}) in the rated operation in the same manner as the first operation support section 303, or may refer to the operation-support internal data 322 stored as the calculation results calculated by the first operation support section 303.

$$\begin{matrix}[ Math . 12 ] & \\ {F}_{cmdset} = ( {Q}_{set} / {Q}_{rated} ) \cdot {F}_{rated} & ( 12 )\end{matrix}$$

Next, in step S321, an operating rotational speed (Nₛₑₜ) corresponding to the command frequency (F_{cmdset}) in the set flow-rate operation is calculated based on the command frequency (F_{cmdset}) in the set flow-rate operation and the number of motor poles (PoleCount) by the following equation (13).

$$\begin{matrix}[ Math . 13 ] & \\ {N}_{set} = 120 \cdot {F}_{out} / PoleCount & ( 13 )\end{matrix}$$

Next, in step S322, a rotational-speed ratio (Nᵣₐₜᵢₒₛₑₜ) in the set flow-rate operation is calculated based on the operating rotational speed (Nₛₑₜ) in the set flow-rate operation and the rated rotational speed (N_{rated}) by the following formula (14).

$$\begin{matrix}[ Math . 14 ] & \\ {N}_{ratioset} = {N}_{n o w} / {N}_{r a t e d} & ( 14 )\end{matrix}$$

Next, in step S323, a total pump head (Hₛₑₜ) in the set flow-rate operation is identified from a point that satisfies the set flow rate (Qₛₑₜ) on the system curve (CV_{sys}(Q)).

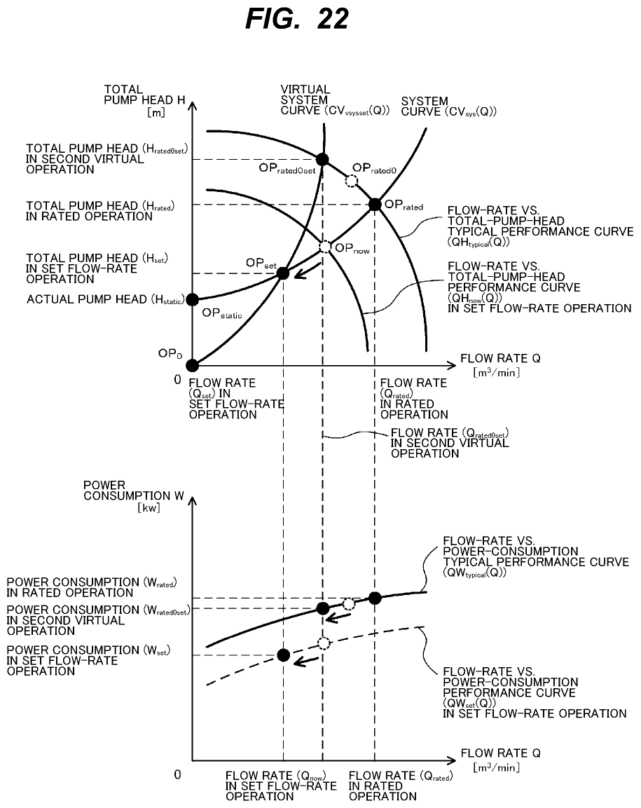

Next, in step S330, a virtual system curve (CV_{vsysset}(Q)) in the set flow-rate operation is created that passes through a point (OP₀) specified by the flow rate of 0 and the total pump head of 0 and a set flow-rate operating point (OPₛₑₜ) specified by the set flow rate (Qₛₑₜ) and the total pump head (Hₛₑₜ) in the set flow-rate operation in a relationship between flow rate and total pump head (see FIG. 22 described later).

Next, in step S331, flow rate (Q_{rated0set}) and total pump head (H_{rated0set}) in a second virtual rated operation corresponding to a rated operation in a virtual state in which actual pump head in the set flow-rate operation is 0 are identified as a second virtual rated operating point (OP_{rated0set}) based on an intersection of the virtual system curve (CV_{vsysset}(Q)) in the set flow-rate operation and the flow-rate vs. total-pump-head typical performance curve (QH_{typical}(Q)).

Next, in step S332, power consumption (W_{rated}) in the rated operation is identified from a point that satisfies the flow rate (Q_{rated}) in the rated operation on the flow-rate vs. power-consumption typical performance curve (QW_{typical}(Q)), and power consumption (W_{rated0set}) in the second virtual rated operation is identified from a point that satisfies the flow rate (Q_{rated0set}) in the second virtual rated operation.

Next, in step S333, power consumption (Wₛₑₜ) in the set flow-rate operation is calculated from the power consumption (W_{rated0set}) in the second virtual rated operation based on the rotational-speed ratio (Nᵣₐₜᵢₒₛₑₜ) between the operating rotational speed (Nₛₑₜ) in the set flow-rate operation and the rated rotational speed (N_{rated}) by the following formula (15).

$$\begin{matrix}[ Math . 15 ] & \\ {W}_{set} = {W}_{rated 0 set} \cdot {( {N}_{ratioset} )}^{3} & ( 15 )\end{matrix}$$

Next, in step S334, energy-saving power (ESWₛₑₜ) in the set flow-rate operation is calculated by subtracting the power consumption (Wₛₑₜ) in the set flow-rate operation from the power consumption (W_{rated}) in the rated operation by the following formula (16). Energy-saving rate (ESRₛₑₜ) in the set flow-rate operation is calculated based on a ratio of the energy-saving power (ESWₛₑₜ) in the set flow-rate operation to the power consumption (W_{rated}) in the rated operation by the following formula (17).

$$\begin{matrix}[ Math . 16 ] & \\ {ESW}_{set} = {W}_{rated} - {W}_{set} & ( 16 )\end{matrix}$$

$$\begin{matrix}[ Math . 17 ] & \\ {ESR}_{set} = ( {ESW}_{set} / {W}_{rated} ) \cdot 100 & ( 17 )\end{matrix}$$

FIG. 22 is a graph showing a relationship between flow rate and total pump head in the set flow-rate operation, and a relationship between flow rate and power consumption. The virtual system curve (CV_{vsysset}(Q)) in the set flow-rate operation is created in the step S330 as a quadratic curve that passes through the point (OP₀) and the set flow-rate operating point (OPₛₑₜ). The second virtual rated operating point (OP_{rated0set}) is identified in the step S331 as the intersection of the virtual system curve (CV_{vsysset}(Q)) in the set flow-rate operation and the flow-rate vs. total-pump-head typical performance curve (QH_{typical}(Q)). The power consumption (W_{rated}) in the rated operation and the power consumption (W_{rated0set}) in the second virtual rated operation are identified in the step S332 by substituting each of the flow rate (Q_{rated}) in the rated operation and the flow rate (Q_{rated0set}) in the second virtual rated operation into the flow-rate vs. power-consumption typical performance curve (QW_{typical}(Q)). The power consumption (Wₛₑₜ) in the set flow-rate operation is calculated in the step S333 by multiplying the power consumption (W_{rated0set}) in the second virtual rated operation by the cube of the rotational-speed ratio (Nᵣₐₜᵢₒₛₑₜ). It is noted that a flow-rate vs. power-consumption performance curve (QWₛₑₜ(Q)) in the set flow-rate operation shown by a dashed line in FIG. 22 is not calculated as a quadratic curve, but is shown for reference.

In step S340, the second operation support section 304 then generates second operation support screen information that displays calculation results of the operating conditions in the set flow-rate operation as results of performing the second operation support process as described above, and updates the second operation support screen 17 based on the second operation support screen information.

FIG. 23 is a diagram showing an example of a second operation support screen 17a after updated. The updated second operation support screen 17a has the same configuration as that of the second operation support screen 17 shown in FIG. 21. A second calculation-result display section 172a displays, for example, the command frequency (F_{cmdset}), the total pump head (Hₛₑₜ), the energy-saving rate (ESRₛₑₜ), and the operating rotational speed (Nₛₑₜ) as the operating conditions in the set flow-rate operation.

The second calculation-result display section 172a may display other data as long as the data has been stored in the operation-support internal data 322 in the second operation support process.

In step S350, the second operation support section 304 then transmits a frequency-setting request including the command frequency (F_{cmdset}) in the set flow-rate operation to the support target device (in this example, the pump device 2 that has performed the test operation) in response to pressing of a command-frequency setting button 173a on the second operation support screen 17a, so that the operating frequency (Fₒᵤₜ) of the support target device is set (changed) to the command frequency (F_{cmdset}) in the set flow-rate operation (in this example, “135.0”). As a result, the support target device controls the rotating operation of the motor 21 based on the operating frequency (Fₒᵤₜ). If the command-frequency setting button 173a is not pressed, and, for example, a new set flow rate (Qₛₑₜ) is set by the set flow-rate input section 170 and the operating-condition calculating button 171 is pressed, the second operation support section 304 may perform the processes from the step S320 in the same manner as if the user input of the new set flow rate (Qₛₑₜ) is received in the step S311.

As described above, the pump-operation support apparatus 3 and the pump-operation support method according to the present embodiment performs the second operation support process to thereby calculate the command frequency (F_{cmdset}) for operating the support target device at the set flow rate (Qₛₑₜ) which is a target flow rate determined by the user under the condition that the support target device has specific performance characteristics and installed in a specific installation situation. Therefore, operation support for the pump device 2 can be easily conducted without using a flow meter for the support target device. In addition, since the energy-saving rate (ESRₛₑₜ) when the support target device is operated is calculated, energy saving effect when the support target device is operated at the set flow rate (Qₛₑₜ) can be checked without using, for example, a watt-hour meter or the like, for the support target device.

### Other Embodiments

The present invention is not limited to the above-described embodiments, and various modifications can be made and used without deviating from the scope of the present invention. All of them are included in the technical concept of the present invention.

In the above-described embodiments, the pump-operation support apparatus 3 has the function of performing the pump-operation support method, while part of the function of the pump-operation support apparatus 3 (particularly the function of the control section 30) may be incorporated into the pump device 2 or the pump database device 4. Further, the pump-operation support apparatus 3 may function as a stand-alone type device by storing necessary data (e.g., the pump database 40) in the memory section 32, or may function as a server-type device, a cloud-type device, a central-monitoring-center-type device, or the like, and may provide various types of screen information to a client-type device capable of receiving various input manipulations.

In the above-described embodiments, the pump-operation support apparatus 3 operates according to the flowcharts shown in FIGS. 6, 13, 14, 19, and 20, while the order of execution of the steps may be changed as appropriate, or some steps may be omitted. For example, the pump-operation support apparatus 3 may appropriately transpose the order of the steps S100 to S125 of displaying the screens 10 to 17, or may omit some of the steps S100 to S125 of displaying the screens 10 to 17. Further, the pump-operation support apparatus 3 may omit the second operation support process (the step S300) and perform only the first operation support process (the step S200), or may omit the first operation support process (the step S200) and perform only the second operation support process (the step S300).

In the above-described embodiments, the pump-operation support apparatus 3 displays on the screen the calculation results of the operating conditions in the reference operation and the calculation results of the operating conditions in the set flow-rate operation, while these calculation results may be stored in an external storage device or storage medium, or may be transmitted to any external device via the network 5.

In the above-described embodiments, the screens 10 to 17 are displayed when the pump-operation support apparatus 3 performs the pump-operation support method, while the display contents, the display form, the display layout, the input method, etc. of the screens 10 to 17 may be appropriately changed. Further, each of the screens 10 to 17 may be displayed as a plurality of screens, and for example, the second operation support screens 17 and 17a may be displayed as separate screens, with the second operation support screen 17 having the set flow rate input section 170 and the operating-condition calculating button 171, and the second operation support screen 17a having the second calculation-result display section 172 and the command-frequency setting button 173.

### INDUSTRIAL APPLICABILITY

The present invention is applicable to a pump-operation support method and a pump-operation support apparatus.

### REFERENCE SIGNS LIST

1 . . . pump-operation support system, 2 . . . pump device, 3 . . . pump-operation support apparatus,
4 . . . pump database device, 5 . . . network,
10 . . . model-number input screen, 11 . . . installation-use input screen, 12 . . . actual-pump-head input screen,
13 . . . operating-frequency input screen, 14 . . . pressure input screen,
15 . . . measurement-point-height-difference input screen,
16 . . . first operation support screen, 17, 17a . . . second operation support screen,
20 . . . pump section, 21 . . . motor, 22 . . . pump controller,
30 . . . control section, 31 . . . communication section, 32 . . . memory section, 33 . . . input section,
34 . . . output section,
40 . . . pump database,
100 . . . model-number input section, 110 . . . installation-use input section,
120 . . . installation-use display section, 121 . . . actual-pump-head input section,
130 . . . installation-use display section, 131 . . . operating-frequency input section,
140 . . . installation-use display section, 141 . . . pressure input section,
150 . . . installation-use display section,
151 . . . measurement-point-height-difference input section,
160 . . . input-content display section, 161 . . . first calculation-result display section,
162 . . . flow-rate setting button,
170 . . . set flow-rate input section, 171 . . . operating-condition calculating button,
172, 172a . . . second calculation-result display section,
173, 173a . . . command-frequency setting button (command-frequency setting instruction section)
300 . . . performance-characteristic acquisition section,
301 . . . installation-state acquisition section, 302 . . . operation-state acquisition section,
303 . . . first operation support section, 304 . . . second operation support section,
320 . . . pump-operation support program, 321 . . . operation-support acquisition data,
322 . . . operation-support internal data

1. A pump-operation support method of supporting operation of a pump device using a computer, comprising:
a performance-characteristic acquisition process of acquiring a flow-rate vs. total-pump-head typical performance curve (QH_{typical}(Q)) in a rated operation and a rated rotational speed (N_{rated}) as performance characteristics of a support target device identified by the model number (Mn) of the pump device;
an installation-state acquisition process of acquiring an actual pump head (H_{static}) as an installation state in which the support target device is installed;
an operation-state acquisition process of acquiring operating frequency (Fₒᵤₜ), suction pressure (P_{suction}), and discharge pressure (P_{discharge}) as an operation state of the support target device when the support target device is operated in the installation state; and
a first operation support process of calculating operating conditions in a reference operation of the support target device when the support target device is operated in the installation state and the operation state; and,
a second operation support process of calculating operating conditions in set flow-rate operation of the support target device when the support target device is operated in the installation state and at a set flow rate (Qₛₑₜ), when the set flow rate (Qₛₑₜ) is input as a flow rate at which the support target device is operated in the installation state,
wherein the first operation support process includes calculating flow rate (Q_{now}) and total pump head (H_{now}) in the reference operation based on the performance characteristics, the installation state, and the operation state, and
the second operation support process includes:
creating a system curve (CV_{sys}(Q)) that passes through a point specified by the actual pump head (H_{static}) and a reference operating point specified by the flow rate (Q_{now}) and the total pump head (H_{now}) in the reference operation in a relationship between flow rate and total pump head;
identifying flow rate (Q_{rated}) and total pump head (H_{rated}) in the rated operation as a rated operating point based on an intersection of the system curve (CV_{sys}(Q)) and the flow-rate vs. total-pump-head typical performance curve (QH_{typical}(Q)); and
calculating a command frequency (F_{cmdset}) in the set flow-rate operation based on a ratio of the set flow rate (Qₛₑₜ) to the flow rate (Q_{rated}) in the rated operation and a rated operating frequency (F_{rated}) corresponding to the rated rotational speed (N_{rated}).

2. The pump-operation support method according to claim 1, wherein the operation-state acquisition process further includes acquiring a measurement-point-height difference (H_{diff}) as the operation state, and
the first operation support process includes:
calculating the total pump head (H_{now}) in the reference operation based on the suction pressure (P_{suction}), the discharge pressure (P_{discharge}), and the measurement-point-height difference (H_{diff});
calculating a flow-rate vs. total-pump-head performance curve (QH_{now}(Q)) in the reference operation from the flow-rate vs. total-pump-head typical performance curve (QH_{typical}(Q)) based on a rotational-speed ratio (Nᵣₐₜᵢₒ) between an operating rotational speed (N_{now}) corresponding to operating frequency (Fₒᵤₜ) in the reference operation and the rated rotational speed (N_{rated}); and
identifying the flow rate (Q_{now}) in the reference operation from a point that satisfies the total pump head (H_{now}) in the reference operation on the flow-rate vs. total-pump-head performance curve in the reference operation.

3. The pump-operation support method according to claim 1, wherein the performance-characteristic acquisition process further includes acquiring a flow-rate vs. power-consumption typical performance curve (QW_{typical}(Q)) in the rated operation as the performance characteristics, and
the first operation support process includes:
creating a system curve (CV_{sys}(Q)) that passes through a point specified by the actual pump head (H_{static}) and a reference operating point specified by the flow rate (Q_{now}) and the total pump head (H_{now}) in the reference operation in a relationship between flow rate and total pump head;
identifying flow rate (Q_{rated}) and total pump head (H_{rated}) in the rated operation as a rated operating point based on an intersection of the system curve (CV_{sys}(Q)) and the flow-rate vs. total-pump-head typical performance curve (QH_{typical}(Q));
creating a virtual system curve (CV_{vsys}(Q)) in the reference operation that passes through the reference operating point and a point specified by flow rate of 0 and total pump head of 0 in the relationship between the flow rate and the total pump head;
identifying flow rate (Q_{rated0}) and total pump head (H_{rated0}) in a first virtual rated operation corresponding to the rated operation in a virtual state in which actual pump head in the reference operation is 0, based on an intersection of the virtual system curve (CV_{vsys}(Q)) in the reference operation and the flow-rate vs. total-pump-head typical performance curve (QH_{typical}(Q));
identifying power consumption (W_{rated}) in the rated operation from a point that satisfies flow rate (Q_{rated}) in the rated operation on the flow-rate vs. power-consumption typical performance curve, and identifying power consumption (W_{rated0}) in the first virtual rated operation from a point that satisfies the flow rate (Q_{rated0}) in the first virtual rated operation;
calculating power consumption (W_{now}) in the reference operation from the power consumption (W_{rated0}) in the first virtual rated operation based on a rotational-speed ratio (Nᵣₐₜᵢₒ) between operating rotational speed (N_{now}) corresponding to operating frequency (Fₒᵤₜ) in the reference operation and the rated rotational speed (N_{rated}); and
calculating energy-saving power in the reference operation by subtracting the power consumption (W_{now}) in the reference operation from the power consumption (W_{rated}) in the rated operation, and calculating an energy-saving rate (ESR) in the reference operation based on a ratio of the energy-saving power in the reference operation to the power consumption (W_{rated}) in the rated operation.

4. The pump-operation support method according to claim 1, wherein:
the performance-characteristic acquisition process includes generating model-number input screen information into which the model number (Mn) can be input, and acquiring the performance characteristics based on the model number (Mn) that has been input into a model-number input screen based on the model-number input screen information;
the installation-state acquisition process includes generating installation-state input screen information into which the installation state can be input, and acquiring the installation state via an installation-state input screen based on the installation-state input screen information;
the operation-state acquisition process includes generating operation-state input screen information into which the operation state can be input, and acquiring the operation state via the operation-state input screen based on the operation-state input screen information; and
the first operation support process includes generating first operation support screen information that displays a calculation result of the operating conditions in the reference operation calculated by the first operation support process.

5. (canceled)

6. The pump-operation support method according to claim 1, wherein the performance-characteristic acquisition process further includes acquiring a flow-rate vs. power-consumption typical performance curve (QW_{typical}(Q)) in the rated operation as the performance characteristics,
the second operation support process includes:
identifying a total pump head (Hₛₑₜ) in the set flow-rate operation from a point that satisfies the set flow rate (Qₛₑₜ) on the system curve;
creating a virtual system curve (CV_{vsysset}(Q)) in the set flow-rate operation that passes through a point specified by the flow rate of 0 and the total pump head of 0 and a set flow-rate operating point specified by the set flow rate (Qₛₑₜ) and the total pump head (Hₛₑₜ) in the set flow-rate operation in the relationship between flow rate and total pump head;
identifying flow rate (Q_{rated0set}) and total pump head (H_{rated0set}) in a second virtual rated operation corresponding to the rated operation in a virtual state in which actual pump head in the set flow-rate operation is 0, based on an intersection of the virtual system curve (CV_{vsysset}(Q)) in the set flow-rate operation and the flow-rate vs. total-pump-head typical performance curve (QH_{typical}(Q));
identifying power consumption (W_{rated}) in the rated operation from a point that satisfies flow rate in the rated operation on the flow-rate vs. power-consumption typical performance curve, and identifying power consumption (W_{rated0set}) in the second virtual rated operation from a point that satisfies flow rate in the second virtual rated operation;
calculating power consumption (Wₛₑₜ) in the set flow-rate operation from the power consumption (W_{rated0set}) in the second virtual rated operation based on a rotational-speed ratio between operating rotational speed (Nₛₑₜ) corresponding to the command frequency (F_{cmdset}) in the set flow-rate operation and the rated rotational speed (N_{rated}); and
calculating energy-saving power in the set flow-rate operation by subtracting the power consumption (Wₛₑₜ) in the set flow-rate operation from the power consumption (W_{rated}) in the rated operation, and calculating energy-saving rate (ESRₛₑₜ) in the set flow-rate operation based on a ratio of the energy-saving power in the set flow-rate operation to the power consumption in the rated operation.

7. The pump-operation support method according to claim 1, wherein the second operation support process includes generating second operation support screen information including:
a set flow-rate input section capable of inputting the set flow rate (Qₛₑₜ);
a second calculation-result display section that displays a calculation result of operating conditions in the set flow-rate operation calculated by the second operation support process based on the set flow rate (Qₛₑₜ) input by the set flow-rate input section; and
a command-frequency setting instruction section capable of inputting a setting instruction to set the command frequency (F_{cmdset}) in the set flow-rate operation to the support target device, the command frequency (F_{cmdset}) serving as the operating conditions in the set flow-rate operation calculated by the second operation support process.

8. A pump-operation support apparatus comprising:
a performance-characteristic acquisition section configured to acquire a flow-rate vs. total-pump-head typical performance curve (QH_{typical}(Q)) in a rated operation and a rated rotational speed (N_{rated}) as performance characteristics of a support target device identified by the model number (Mn) of the pump device;
an installation-state acquisition section configured to acquire an actual pump head (H_{static}) as an installation state in which the support target device is installed;
an operation-state acquisition section configured to acquire operating frequency (Fₒᵤₜ), suction pressure (P_{suction}), and discharge pressure (P_{discharge}) as an operation state of the support target device when the support target device is operated in the installation state; and
a first operation support section configured to calculate operating conditions in a reference operation of the support target device when the support target device is operated in the installation state and the operation state; and,
a second operation support section configured to calculate operating conditions in set flow-rate operation of the support target device when the support target device is operated in the installation state and at a set flow rate (Qₛₑₜ), when the set flow rate (Qₛₑₜ) is input as a flow rate at which the support target device is operated in the installation state,
wherein the first operation support section is configured to calculate flow rate (Q_{now}) and total pump head (H_{now}) in the reference operation based on the performance characteristics, the installation state, and the operation state, and
the second operation support section is configured to:
create a system curve (CV_{sys}(Q)) that passes through a point specified by the actual pump head (H_{static}) and a reference operating point specified by the flow rate (Q_{now}) and the total pump head (H_{now}) in the reference operation in a relationship between flow rate and total pump head;
identify flow rate (Q_{rated}) and total pump head (H_{rated}) in the rated operation as a rated operating point based on an intersection of the system curve (CV_{sys}(Q) and the flow-rate vs. total-pump-head typical performance curve (QH_{typical}(Q)); and
calculate a command frequency (F_{cmdset}) in the set flow-rate operation based on a ratio of the set flow rate (Qₛₑₜ) to the flow rate (Q_{rated}) in the rated operation and a rated operating frequency (F_{rated}) corresponding to the rated rotational speed (N_{rated}).
